(19) United States
(12) Patent Application Publication
(10) Pub. No.: US 2026/0210273 A1
(43) Pub. Date: Jul. 23, 2026

(54) INNER SHROUD SECTOR FOR AN AIRCRAFT TURBINE ENGINE

(71) Applicant: SAFRAN AIRCRAFT ENGINES, Paris (FR)

(72) Inventors: Philippe Didier Edmond Andre LIberal NABIAS, Moissy-Cramayel (FR); Florian Benjamin Kevin LACROIX, Moissy-Cramayel (FR); Julien VITRA, Moissy-Cramayel (FR); Arnaud POUPARD, Moissy-Cramayel (FR); Richard MATHON, Moissy-Cramayel (FR)

(73) Assignee: SAFRAN AIRCRAFT ENGINES, Paris (FR)

(21) Appl. No.: 19/140,497

(22) PCT Filed: Jan. 22, 2024
(86) PCT No.: PCT/EP2024/051375

§ 371 Date: Jun. 18, 2025

(30) Foreign Application Priority Data
Jan. 25, 2023 (FR) 2300663

(51) Int. Cl. F01D 25/24; F01D 25/00

(52) U.S. Cl. CPC F01D 25/24; F01D 25/005; F05D 2300/603

(57) ABSTRACT

The invention relates to an inner shroud sector configured to be mounted in an aircraft turbine engine, the inner shroud being a rotating part having a longitudinal axis (X) oriented from upstream to downstream, the inner shroud sector having a main body having an outer surface (Sext) configured to internally delimit a secondary flow path, the main body having an upstream end configured to be attached to a hub of an intermediate casing of the aircraft turbine engine, the main body being made of a composite material having a plurality of reinforcing fibres in a matrix, the inner shroud sector having at least one hollow column mounted on the upstream end of the main body, each hollow column extending radially and being configured to accommodate an attachment element for attaching the inner shroud sector to the hub of the intermediate casing.

### TECHNICAL FIELD

The present invention relates to the field of aircraft turbine engine casings and more specifically to an inner shroud sector.

### BACKGROUND

In known manner, with reference to FIG. 1, an aircraft turbine engine 500, of longitudinal axis X, comprises from upstream to downstream a fan 200, a low-pressure compressor 220, a high-pressure compressor 230, a combustion chamber 240, a high-pressure turbine 250 and a low-pressure turbine 260. The compressors 220, 230, the combustion chamber 240 and the turbines 250, 260 together define a primary flow path 400 for circulating an air flow, delimited externally by a central casing 270. The aircraft turbine engine 500 also comprises a secondary flow path 410 for circulating an air flow which extends externally around the primary flow path 400 and is surrounded by a nacelle 300.

In a known manner and as illustrated in FIG. 1, the aircraft turbine engine 500 comprises an intermediate casing 190 comprising an inner shroud 100 and an outer shroud 180 which respectively delimit the interior and exterior of the secondary flow path 410. The inner shroud 100 and the outer shroud 180 are connected by arms 170 extending radially into the secondary flow path 410 downstream of a row of outlet guide vanes (OGV) 330. The outer shroud 180 extends in the extension downstream from the fan casing 210 and in the extension upstream from an outer fan duct 320. The inner shroud 100 extends in the extension upstream from an inner fan duct 310. The inner fan duct 310 and the central casing 270 together define a compartment core 280 extending radially between the primary flow path 400 and the secondary flow path 410.

In a known way, the inner shroud 100 is attached upstream to an intermediate casing hub 160. In practice, the inner shroud 100 is formed by several angular inner shroud sectors, typically in the form of one-piece titanium parts. Each inner shroud sector is attached to the hub 160 by an assembly of attachment screws inserted into through housings in the inner shroud sector, formed by piercing into an extra thickness of titanium. The high mechanical strength of titanium allows the inner shroud sectors to transmit forces efficiently into the intermediate casing. Such inner shroud sectors also form a fire barrier, thanks to titanium's high thermal resistance to deformation. However, such inner shroud sectors have the disadvantage of high mass. This has the effect of making the aircraft turbine engine 500 heavier and therefore increasing its energy consumption in flight.

It is known from the application WO2010007220A2 to use a composite material for one or more elements of an aircraft turbine engine casing. The applications FR3108679A1, FR2992353A1 and FR3115832A1 are also known.

The invention thus aims to reduce the mass of an inner shroud sector while maintaining its fire barrier properties and its ability to transmit mechanical forces into the intermediate casing.

### SUMMARY

The invention relates to an inner shroud sector configured to be mounted in an aircraft turbine engine, the inner shroud being a revolving part defined with respect to a longitudinal axis oriented from upstream to downstream, the inner shroud sector comprising a main body comprising an outer surface configured to internally delimit a secondary flow path of the aircraft turbine engine, the main body comprising an upstream end configured to be attached to a hub of an intermediate casing of the aircraft turbine engine.

The invention is remarkable in that:
the main body is made of a composite material comprising a plurality of reinforcing fibers in a matrix, and
the inner shroud sector comprises at least one hollow column mounted on the upstream end of the main body, each hollow column extending radially and being configured to receive an attachment element for attaching the inner shroud sector to the hub of the intermediate casing.

Thanks to the composite material, the mass of an inner shroud sector according to the invention is reduced. The use of composite material for such an inner shroud, which has to have a fairly good fire resistance, and which has many attachment points because it is made in the form of sectors assembled together, is unprecedented. In addition, the hollow columns according to the invention are inserts, which advantageously avoid the need to form extra thicknesses in the main body, which also helps to reduce weight. This also allows the composite material to be compressed easily and evenly during the manufacture of the main body.

According to one aspect of the invention, the upstream end of the main body comprises at least one first through hole, said at least one hollow column being crimped in said at least one first through hole. Advantageously, this type of mounting allows to obtain an attachment that is resistant to any deformation of the composite material under the effect of heat.

According to one aspect of the invention, the upstream end of the main body comprises a first longitudinal wall, wherein each first through hole is formed, and a second longitudinal wall spaced radially apart from the first longitudinal wall and wherein at least one second through hole is formed, said at least one hollow column connecting said at least one first through hole and said at least one second through hole. Such a geometry does not require any local extra thickness and is advantageously suited to a main body formed from a composite material.

According to one aspect of the invention, the upstream end of the main body comprises a third wall connecting the first longitudinal wall and the second longitudinal wall, the third wall being separated from each hollow column by a free volume. The absence of filler material between the hollow columns and the third wall saves weight.

According to one aspect of the invention, the main body comprises an inner surface opposite the outer surface, each first through hole opening onto the inner surface. The crimping is advantageously implemented on the side of the inner surface most likely to be subjected to mechanical and thermal deformation.

According to one aspect of the invention, the upstream end of the main body comprises a first inner longitudinal wall and a second outer longitudinal wall spaced radially apart from each other, at least one first through hole being formed in the first longitudinal wall, at least one second hole being formed in the second longitudinal wall, said at least one hollow column connecting said at least one first through hole and said at least one second through hole, the upstream end of the main body comprising a third wall connecting the first longitudinal wall and the second longitudinal wall downstream of said at least one hollow column. Such a geometry does not require any local extra thickness and is advantageously suited to a main body formed from a composite material. This type of geometry is particularly well suited to clamping a thick part while ensuring a good transmission of mechanical forces. By significant thickness, we mean an average thickness of the main body of the upstream end greater than 1 cm, preferably greater than 1.5 cm.

According to one aspect of the invention, said at least one hollow column is crimped in said at least one first through hole. Advantageously, this type of mounting allows to obtain an attachment that is resistant to any deformation of the composite material under the effect of heat. The crimping is advantageously implemented on the side of the inner surface most likely to be subjected to mechanical and thermal deformation. The crimp also helps to protect the turbine engine in the event of a fire by preventing the heat from spreading. The crimping prevents the fire from spreading through the first through hole, compared to a mounting with clearance or with crimping or gluing the column to the second hole in the second wall, on the external side.

According to one aspect of the invention, a clearance is present between said at least one hollow column and said at least one second through hole. The presence of clearance prevents hyperstatic mounting of the hollow columns on the main body.

According to one aspect of the invention, the first longitudinal wall is spaced radially from the second longitudinal wall by a distance greater than four times a thickness of the first longitudinal wall, preferably greater than eight times a thickness of the first longitudinal wall. The distance in question corresponds to the height of the hollow column and is preferably greater than 1 cm, preferably greater than 1.5 cm. The inner shroud sector comprises a significant thickness, for which the hollow column in accordance with the invention allows a clamping where the mechanical forces are transmitted efficiently while reducing the mass of the turbine engine. In the absence of a hollow column, a very large number of layers of composite material would be required to ensure the clamping of such a thickness, which is out of the question.

According to one aspect of the invention, the third wall is separated from said at least one hollow column by a free volume. The absence of filler material between the hollow columns and the third wall saves weight.

According to one aspect of the invention, the first longitudinal wall, the second longitudinal wall and the third wall comprise a plurality of layers of composite material secured together, with at least one layer known as the fire-resistant layer extending continuously in the first longitudinal wall and the third wall. In a preferred aspect, the fire-resistant layer defines the entire inner surface of the main body. The continuity of the composite material layer thus forms a fire barrier on the side of the inner surface most likely to be subjected to mechanical and thermal deformation.

According to one aspect of the invention, said at least one hollow column is metallic, preferably stainless steel. Stainless steel is defined as steel comprising less than 1.2% carbon and more than 10.5% chromium. Advantageously, stainless steel is sufficiently deformable to allow crimping.

The invention also relates to an intermediate casing for an aircraft turbine engine comprising a hub and at least one inner shroud sector as described above, the intermediate casing extending along the longitudinal axis X, the intermediate casing comprising at least one attachment element for attaching the upstream end of the inner shroud sector to the hub, each attachment element extending into a hollow column of the inner shroud sector.

The invention also relates to an aircraft turbine engine comprising a secondary flow path and an intermediate casing comprising a hub and at least one inner shroud sector as described above, the aircraft turbine engine extending along the longitudinal axis X of the inner shroud sector, the outer surface of the inner shroud sector internally delimiting the secondary flow path, the aircraft turbine engine comprising at least one attachment element for attaching the upstream end of the inner shroud sector to the hub of the intermediate casing, each attachment element extending into a hollow column of the inner shroud sector.

### BRIEF DESCRIPTION OF THE DRAWINGS

The invention will be better understood on reading the following description, given by way of example, with reference to the following figures, given by way of non-limiting examples, wherein identical references are given to similar objects.

FIG. 1 is a schematic representation in longitudinal half-section of an aircraft turbine engine according to the prior art.

FIG. 2 is a schematic representation in longitudinal half-section of an aircraft turbine engine equipped with an intermediate casing with an assembly of inner shroud sectors according to one embodiment of the invention.

FIG. 3 is a schematic perspective view of the intermediate casing shown in FIG. 2, FIG. 4 is a schematic representation in perspective from upstream of the inner shroud sector according to one embodiment of the invention.

FIG. 5 is a schematic representation in longitudinal cross-section of the inner shroud sector of FIG. 4 attached to the hub of the intermediate casing according to one embodiment of the invention.

FIG. 6 is a schematic representation of an operation for mounting a hollow column on the main body of the inner shroud sector of FIG. 4.

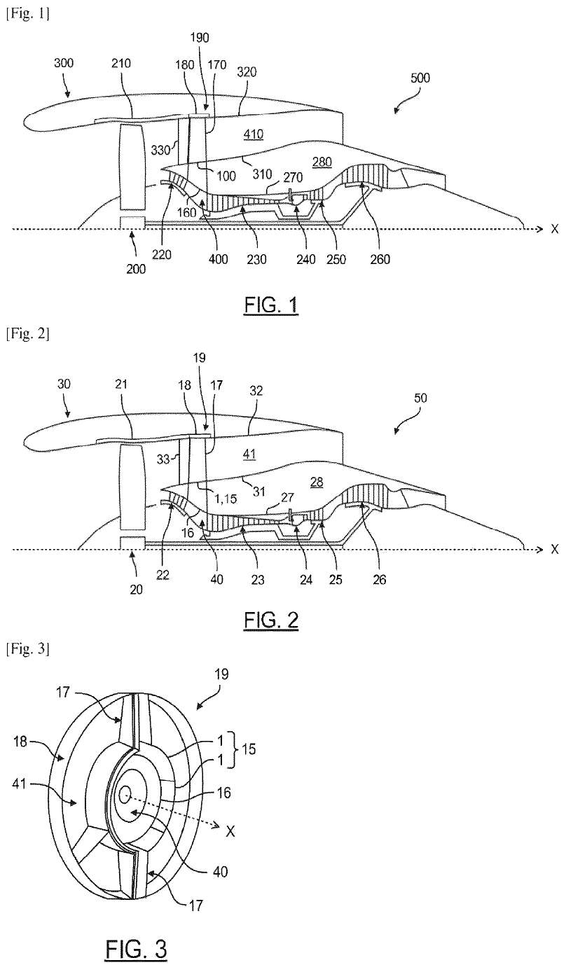

It should be noted that the figures set out the invention in detail in order to implement the invention, said figures of course being able to be used to better define the invention if necessary.

### DETAILED DESCRIPTION

With reference to FIG. 2 and as described in the preamble, an aircraft turbine engine 50 classically extends along a longitudinal axis X oriented from upstream to downstream. Hereafter, the terms “upstream” and “downstream” are defined in relation to the orientation of the longitudinal axis X. The terms “inner” and “outer” are defined in relation to a radial axis extending orthogonally to the longitudinal axis X.

Still with reference to FIG. 2, the aircraft turbine engine 50 typically comprises, from upstream to downstream, a fan 20, a low-pressure compressor 22, a high-pressure compressor 23, a combustion chamber 24, a high-pressure turbine 25 and a low-pressure turbine 26. The compressors 22, 23, the combustion chamber 24 and the turbines 25, 26 together define a primary flow path 40 for an air flow, delimited externally by a central casing 27. The aircraft turbine engine 50 also classically comprises a secondary flow path 41 for circulating an air flow which extends externally around the primary flow path 40 and is surrounded by a nacelle 30. An aircraft turbine engine 50 of this type is known as a bypass engine.

With reference to FIGS. 2 and 3, the aircraft turbine engine 50 comprises an intermediate casing 19 comprising an inner shroud 15 and an outer shroud 18 of longitudinal axis X which delimit the secondary flow path 41 internally and externally respectively. The intermediate casing 19 also comprises a hub 16 to which the inner shroud 15 is attached upstream. The hub 16 extends along the longitudinal axis X internally with respect to the inner shroud 15. In the example shown in FIG. 3, the hub 16 externally delimits the primary flow path 40. In this example, the intermediate casing 19 also comprises arms 17 connecting the inner shroud 15 and the outer shroud 18, which extend radially into the secondary flow path 41, downstream of a row of outlet guide vanes (OGV) 33.

With reference to FIGS. 2 and 3, the outer shroud 18 extends in the extension downstream from a fan casing 21 and, here, in the extension upstream from an outer fan duct 32. The inner shroud 15 extends opposite the outer shroud 18, in the upstream extension of an inner fan duct 31. The inner fan duct 31 and the central casing 27 together typically delimit a compartment core 28 extending radially between the primary flow path 40 and the secondary flow path 41.

As illustrated in FIG. 3, the inner shroud 15 is a revolving part defined with respect to the longitudinal axis X in the aircraft turbine engine 50, the longitudinal axis X hereinafter designating indifferently the axis of the turbine engine 50 and the axis of the inner shroud 15, which are coincident. As illustrated in FIG. 3, the inner shroud 15 is formed by an assembly of inner shroud sectors 1 angularly distributed around the longitudinal axis X. The inner shroud sectors 1 extend over a variable angular width in this example.

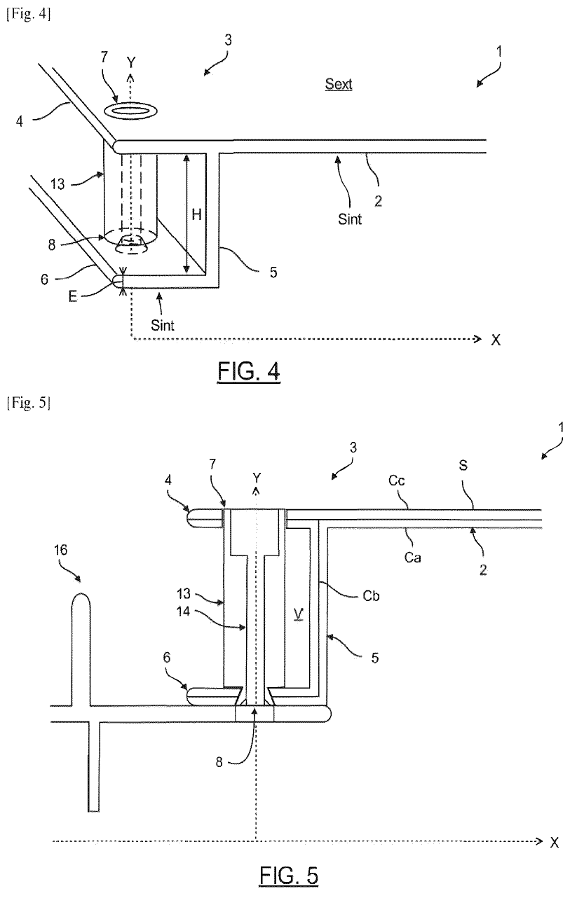

According to the invention and as illustrated in FIGS. 4 and 5, each inner shroud sector 1 comprises:
a main body 2 made of a composite material comprising reinforcing fibers in a matrix, and
one or more hollow columns 13 mounted on an upstream end 3 of the main body 2, each hollow column 13 extending radially and being configured to receive an attachment element 14 for attaching the inner shroud sector 1 to the hub 16 of the intermediate casing 19.

Thanks to the composite material, the inner shroud sectors 1 according to the invention advantageously have a reduced mass compared with titanium inner shroud sectors according to the prior art. The use of composite material in an inner shroud sector 1 is unprecedented and goes against its current use, such as in acoustic panels attached to a cowl. Because of its position close to the primary flow path in the engine, the shroud must be able to guarantee mechanical strength in the event of a fire, which discourages the use of a composite material. In addition, the shroud is made up of several sectors connected by numerous attachment points, some of which have a significant clamping thickness, which also discourages the use of a composite material. As will be seen later, an inner shroud sector 1 in accordance with the invention forms a fire barrier and transmits mechanical forces into the intermediate casing.

As illustrated in FIGS. 3 and 4, the main body 2 of an inner shroud sector 1 comprises an outer surface Sext curved towards the longitudinal axis X and an inner surface Sint opposite the outer surface Sext. The outer surface Sext delimits the secondary flow path 41 internally. The inner surface Sint is configured to extend radially against the hub 16 at the upstream end 3 when the intermediate casing 19 is mounted (FIG. 5).

As illustrated in FIGS. 3 and 4, the main body 2 comprises an upstream end 3 on which one or more hollow columns 13 are mounted to secure the intermediate casing 19 to the hub 16. The number of hollow columns 13 depends on the angular width of the inner shroud sector 1, preferably at least two. The hollow columns 13 are preferably distributed over the angular width of the upstream end 3. A single hollow column 13 and its mounting in the main body 2 will be described below, this description being valid for each hollow column 13.

According to a preferred aspect illustrated in FIGS. 3 and 4, the upstream end 3 comprises a first longitudinal wall 6 and a second longitudinal wall 4 spaced radially apart and comprising respectively a first through hole 8 and a second through hole 7 for each hollow column 13. The second longitudinal wall 4 preferably extends in the upstream extension of the main body 2. The first longitudinal wall 6 extends radially inwards from the second longitudinal wall 4. As illustrated in FIG. 4, the radial distance H separating the longitudinal walls 4, 6, corresponding to the height of the hollow column 13, is preferably greater than four times, preferably eight times, a thickness E of the first longitudinal wall 6 or the second longitudinal wall 4. The radial distance H is preferably greater than 1 cm, preferably greater than 1.5 cm. The first through hole 8 and the second through hole 7 associated with the same hollow column 13 are radially aligned along a radial axis Y, the hollow column 13 extending along the radial axis Y in the through holes 7, 8.

According to a preferred aspect illustrated in FIGS. 3 and 4, the longitudinal walls 4, 6 are connected together by a third wall 5. The third wall 5 extends downstream of the longitudinal walls 4, 6. In this example, the third wall 5 extends radially and forms a U with the longitudinal walls 4, 6, the concavity of which faces upstream. Here, the longitudinal walls 4 and 6 extend all along the upstream end 3 of the main body 2 and, together with the third wall 5, delimit a channel, in this case with a U-shaped cross-section, open on the upstream side. Alternatively, the third wall 5 extends in a direction forming, in a plane defined by the longitudinal axis X and a radial axis, an angle of between 10° and 90° with respect to the longitudinal axis X. In this alternative, the third wall 5 preferably extends so that the first longitudinal wall 6 comprises a longitudinal length less than that of the second longitudinal wall 4.

As described previously, the main body 2 is made of a composite material in the form of reinforcing fibers trapped in a matrix. The main body 2 preferably has a one-piece structure. The reinforcing fibers are made of carbon, for example, to give the main body 2 good mechanical strength. The matrix is obtained by heating and compressing a thermosetting material, for example a polyepoxide, known as “epoxy”. Such a material has a malleable structure configured to harden after heating and pressurizing to obtain its final shape.

As illustrated in FIG. 5, the main body 2 comprises an assembly of layers Ca, Cb, Cc of composite material secured together by heating and compression, and forming the one-piece structure.

The main body 2 preferably comprises:
An inner layer Ca defining the entire inner surface Sint of the main body 2, in particular extending continuously into the first longitudinal wall 6 and into the third wall 5 of the upstream end 3,
An outer layer Cc defining the entire outer surface Sext of the main body 2, in particular extending continuously into the second longitudinal wall 4 of the upstream end 3,
An intermediate layer Cb extending only in the upstream end 3, radially between the outer layer Cc and the inner layer Ca, i.e. continuously in the first longitudinal wall 4, in the third wall 5 and in the second longitudinal wall 6.

In this example, the inner layer Ca has a substantially “S”-shaped cross-section, the outer layer Cc has a substantially straight cross-section and the intermediate layer Cb has a substantially “U”-shaped cross-section.

The continuous arrangement of the inner layer Ca, known as the fire-resistant layer Ca, advantageously allows to form a fire barrier between the primary flow path 40 and the secondary flow path 41. The fire-resistant layer Ca helps to contain any outbreak of fire and prevent the spread of heat. The fire barrier is also ensured at the level of the first through holes 8 thanks to a special mounting by crimping of the hollow columns 13, as will be seen later.

In this example, the main body 2 comprises only the three layers Ca, Cb, Cc. Alternatively, the body also comprises other layers sandwiched between the layers Ca, Cb, Cc, preferably in such a way as to maintain a substantially constant thickness.

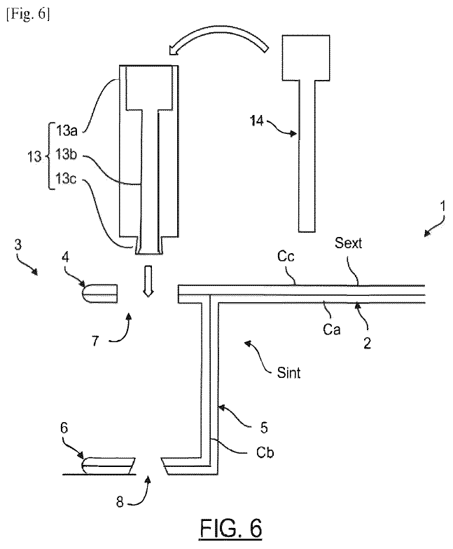

As illustrated in FIGS. 5 and 7, each hollow column 13 is an insert in the form of a through attachment housing mounted radially in the upstream end 3 between the first through hole 8 and the second through hole 7 along a radial axis Y. The hollow column 13 comprises a radial aperture 13b, configured to receive an attachment element 14 such as a screw. As illustrated in FIG. 6, the hollow column 13 also comprises a first end 13c cooperating with the first through hole 7 and a second end 13a cooperating with the second through hole 8.

According to a preferred aspect, the first end 13c is crimped in the first through hole 8, i.e. inserted in the first through hole 8 by deformation of the material. This type of attachment forms a fire barrier at the level of the first through holes 8, in the extension of the fire-resistant layer Ca. The crimping prevents the spread of fire through the first through hole 8 compared to a conventional mounting, particularly with clearance. The crimping means that a form of seal may be maintained at each first through hole 8 (seal between the column 13 and the fire-resistant layer Ca) even if the composite material of the main body 2 deforms slightly under the effect of heat.

Preferably, as illustrated in FIGS. 5 and 7, the first end 13c and the first through hole 8 comprise a frustoconical section increasing from the outside inwards along the radial axis Y which cooperate together. The hollow column 13 is inserted from the outside inwards, then the frustoconical section of the first end 13c is deformed to allow it to cooperate with the first through hole 8 (i.e. to crimp it onto the first longitudinal wall 6). Preferably also, the first end 13c comprises an abutment section configured to abut radially from the outside against the first longitudinal wall 6. The abutment section comprises a larger diameter than the first through hole 8. The frustoconical section and the abutment section of the end 13c together ensure the radial blocking in translation towards the outside and towards the inside respectively of the hollow column 13.

Alternatively, the first end 13c is attached by gluing or riveting in the first through hole 8.

According to a preferred aspect, the second end 13a extends freely in the second through hole 7, i.e. is mounted with clearance in the second through hole 7. This avoids a hyperstatic mounting of the hollow column 13 on the main body 2 and limits the mechanical stresses likely to reduce the service life. As shown in FIG. 6, the second through hole 7 comprises a larger cross-section than the external cross-section of the hollow column 13 so that the hollow column 13 is inserted radially via the end 13a to be mounted on the main body 2.

The hollow column 13 is preferably made of metal to ensure good mechanical strength, preferably stainless steel. Stainless steel is advantageously deformable, which makes it easy to crimp, unlike titanium, for example. Stainless steel is defined as steel comprising less than 1.2% carbon and more than 10.5% chromium. The hollow column 13 is preferably in one-piece.

According to a preferred aspect illustrated in FIGS. 4 and 5, the hollow column 13 is separated from the third wall 5 by a free volume V. Thanks to the crimped mounting, no filler material is required between the hollow column 13 and the third wall 5. This helps to reduce the weight of the inner shroud section 1, in addition to the choice of composite material. Preferably, the U-shaped channel delimited by the three walls 4, 5, 6, has a radial width at least equal to its longitudinal depth, preferably at least equal to 1 cm, preferably at least equal to 1.5 cm. For such a geometry, the use of a filler or reinforcement material would be impractical and ineffective.

Such a hollow column 13 fitted to the main body 2 advantageously allows to simplify the geometry of the main body 2, in particular with a constant thickness, so that the main body 2 may be formed from composite material. In addition, the hollow column 13 avoids the need to form an extra thickness in the third wall 5 to form housings by piercing as in the prior art.

As shown in FIG. 6, the hollow columns 13 are inserted radially into the second through holes 7 and then attached, here by crimping, into the first through holes 8 to form the inner shroud sector 1. The inner shroud sectors 1, together defining the inner shroud 15, are then mounted in the aircraft turbine engine 50 using the attachment elements 14. The attachment elements 14 are inserted radially from the outside into the hollow columns 13 and into the hub 16 of the intermediate casing 19, to attach the inner shroud sectors 1 to the hub 16.

1-10. (canceled)

11. An inner shroud sector configured to be mounted in an aircraft turbine engine, the inner shroud being a revolving part defined with respect to a longitudinal axis oriented from upstream to downstream, the inner shroud sector comprising a main body comprising an outer surface configured to internally delimit a secondary flow path of the aircraft turbine engine, the main body comprising an upstream end configured to be attached to a hub of an intermediate casing of the aircraft turbine engine, the main body being made of a composite material, the inner shroud sector wherein:
the composite material of the main body comprises a plurality of reinforcing fibers in a matrix, and
the inner shroud sector comprises at least one hollow column mounted on the upstream end of the main body, each at least one hollow column extending radially and being configured to receive an attachment element for attaching the inner shroud sector to the hub of the intermediate casing.

12. The inner shroud sector according to claim 11, wherein the upstream end of the main body comprises a first inner longitudinal wall and a second outer longitudinal wall spaced radially apart from one another, at least one first through hole being formed in the first longitudinal wall, at least one second through hole being formed in the second longitudinal wall, said at least one hollow column connecting said at least one first through hole and said at least one second through hole, the upstream end of the main body comprising a third wall connecting the first longitudinal wall and the second longitudinal wall downstream of said at least one hollow column.

13. The inner shroud sector according to claim 12, wherein said at least one hollow column is crimped in said at least one first through hole.

14. The inner shroud sector according to claim 12, wherein a clearance is present between said at least one hollow column and said at least one second through hole.

15. The inner shroud sector according to claim 12, wherein the first longitudinal wall is spaced radially from the second longitudinal wall by a distance greater than four times a thickness of the first longitudinal wall.

16. The inner shroud sector according to claim 1 12, wherein the third wall is separated from said at least one hollow column by a free volume.

17. The inner shroud sector according to claim 12, wherein the first longitudinal wall, the second longitudinal wall and the third wall comprise a plurality of layers of composite material secured together, with at least one layer known as a fire-resistant layer extending continuously in the first longitudinal wall and the third wall.

18. The inner shroud sector according to claim 17, wherein the fire-resistant layer defines the entire inner surface of the main body.

19. The inner shroud sector according to claim 11, wherein said at least one hollow column is metallic.

20. An aircraft turbine engine comprising a secondary flow path and an intermediate casing comprising a hub and at least one inner shroud sector according to claim 11, the aircraft turbine engine extending along the longitudinal axis X of the inner shroud, the outer surface of the inner shroud sector internally delimiting the secondary flow path, the aircraft turbine engine comprising at least one attachment element for attaching the upstream end of the inner shroud sector to the hub of the intermediate casing, each attachment element extending in at least one hollow column of the inner shroud sector.
